(19) United States
(12) Patent Application Publication
(10) Pub. No.: US 2004/0172414 A1
(43) Pub. Date: Sep. 2, 2004

(54) CAD generation management system and computer-readable storage medium

(75) Inventors: Akira Katou, Kawasaki (JP); Kasumi Abe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/629,768

(22) Filed: Jul. 30, 2003

(30) Foreign Application Priority Data
Sep. 13, 2002 (JP) 2002-268803

(51) Int. Cl. G06F 7/00

(52) U.S. Cl. 707/104.1

(57) ABSTRACT

A CAD generation management system is provided with a storage section to store file information in units of generations, an inter-file correspondence table to store corresponding relationships of the file information stored in the storage, including generation information, an icon storage to store icon data corresponding to the file information, and a unit to display relationships of the file information corresponding to the icon data by referring to the inter-file correspondence table and the icon storage and displaying the icon data of the file information stored in the storage section in units of generations.

### BACKGROUND OF THE INVENTION

This application claims the benefit of a Japanese Patent Application No.2002-268803 filed Sep. 13, 2002, in the Japanese Patent Office, the disclosure of which is hereby incorporated by reference.

1. Field of the Invention

The present invention generally relates to Computer-Aided-Design (CAD) generation management systems and computer-readable storage media, and more particularly to a CAD generation management system for managing generations of various data created by CAD, and to a computer-readable storage medium which stores a compute program for causing a computer to carry out such a CAD generation management.

2. Description of the Related Art

A CAD system is generally used to create drawings and the like on a computer by software, and a user (or designer) creates design drawings on a stand-alone CAD system.

But recently, the design drawings to be created by the CAD system are becoming more and more complex. As a result, the trend is for a plurality of users to jointly create the design drawings by connecting a plurality of CAD systems via a network. In this case, each user designs a portion of the design drawings on the CAD system, and the portions designed by the users are integrated to obtain the final design drawings. Such a system is proposed in a Japanese Laid-Open Patent Application No.11-338901, for example.

In the proposed system described above, a first user may design parts and create a parts library thereof, and a second user may utilize the parts library to design a module by assembling the parts. Such a situation frequently occurs when a plurality of users work to jointly create a unit, for example.

But if the first user modifies the contents of the parts library, this modification affects the module designed by the second user who utilizes the parts library. Accordingly, it is important to manage generations of each library that is created. Conventionally a generation management method for confirming a library created by a user has been proposed in a Japanese Laid-Open Patent Application No.6-268066, for example.

The proposed generation management method described above manages the generation of each library, but does not link the libraries. For example, in order for the user to know the related libraries of the drawings, the user must check, one by one, the generation of each library which is related to the each drawing.

Particularly in the case of a three-dimensional CAD which creates the drawing by utilizing a large number of libraries, it is extremely difficult and time consuming to actually check the generation of each library which is related to the drawing.

### SUMMARY OF THE INVENTION

Accordingly, it is a general object of the present invention to provide a novel and useful CAD generation management system and computer-readable storage medium, in which the problems described above are eliminated.

Another and more specific object of the present invention is to provide a CAD generation management system and computer-readable storage medium, which enable easy understanding of relationships of generations of related drawings even when the number of related drawings is large.

Still another object of the present invention is to provide a CAD generation management system comprising a storage section to store file information in units of generations; an inter-file correspondence table to store corresponding relationships of the file information stored in the storage, including generation information; an icon storage to store icon data corresponding to the file information; and a unit to refer to the inter-file correspondence table and the icon storage and to display icon data of the file information stored in the storage section in units of generations, and to display relationships of the file information corresponding to the icon data. According to the CAD generation management system of the present invention, it is possible to enable easy understanding of relationships of generations of related drawings even when the number of related drawings is large.

A further object of the present invention is to provide a CAD generation management system comprising a first storage to store font information indicating generation information; a second storage to store icon data indicating file information; a third storage to store the generation information of the file information; and a unit to refer to the generation information stored in the third storage in response to an instruction to display generation information of target file information, and to create and display the icon data related to the generation information to be displayed by combining the font information stored in the first storage and the icon data stored in the second storage. According to the CAD generation management system of the present invention, it is possible to enable easy understanding of relationships of generations of related drawings even when the number of related drawings is large.

Another object of the present invention is to provide a computer-readable storage medium which stores a computer program for causing a computer to manage generation information of file information, said computer program comprising a procedure to cause the computer to store file information in a storage in units of generations; a procedure to cause the computer to store corresponding relationships of the file information stored in the storage, including generation information, in an inter-file correspondence table; a procedure to cause the computer to store icon data corresponding to the file information in an icon storage; and a control procedure to cause the computer to refer to the inter-file correspondence table and the icon storage and to display icon data of the file information stored in the storage section in units of generations, and to display relationships of the file information corresponding to the icon data. According to the computer-readable storage medium of the present invention, it is possible to enable easy understanding of relationships of generations of related drawings even when the number of related drawings is large.

Still another object of the present invention is to provide a computer-readable storage medium which stores a computer program for causing a computer to manage generation information of file information, said computer program comprising a procedure to cause the computer to store font information indicating generation information in a first storage; a procedure to cause the computer to store icon data indicating file information in a second storage; a procedure to cause the computer to store the generation information of the file information in a third storage; and a control procedure to cause the computer to refer to the generation information stored in the third storage in response to an instruction to display generation information of target file information, and to create and display the icon data related to the generation information to be displayed by combining the font information stored in the first storage and the icon data stored in the second storage. According to the computer-readable storage medium of the present invention, it is possible to enable easy understanding of relationships of generations of related drawings even when the number of related drawings is large.

Other objects and further features of the present invention will be apparent from the following detailed description when read in conjunction with the accompanying drawings.

### BRIEF DESCRIPTION OF THE DRAWINGS

FIG. 1 is a diagram showing a structure an embodiment of a CAD generation management system according to the present invention;

FIG. 2 is a diagram showing a structure of a system database;

FIG. 3 is a flow chart for explaining an operation of the CAD generation management system;

FIG. 4 is a diagram showing an initial screen displayed on the CAD generation management system;

FIG. 5 is a flow chart for explaining an editing process of a CAD program;

FIG. 6 is a diagram showing a structure of an inter-file correspondence table;

FIG. 7 is a diagram for explaining an icon data creating process;

FIG. 8 is a diagram for explaining an icon data display process;

FIG. 9 is a diagram for explaining the icon data display process;

FIG. 10 is a flow chart for explaining the operation of the CAD generation management system;

FIG. 11 is a diagram for explaining the icon data display process; and

FIG. 12 is a diagram for explaining the icon data display process.

### DESCRIPTION OF THE PREFERRED EMBODIMENTS

A description will be given of embodiments of a CAD generation management system according to the present invention and a computer-readable storage medium according to the present invention, by referring to the drawings.

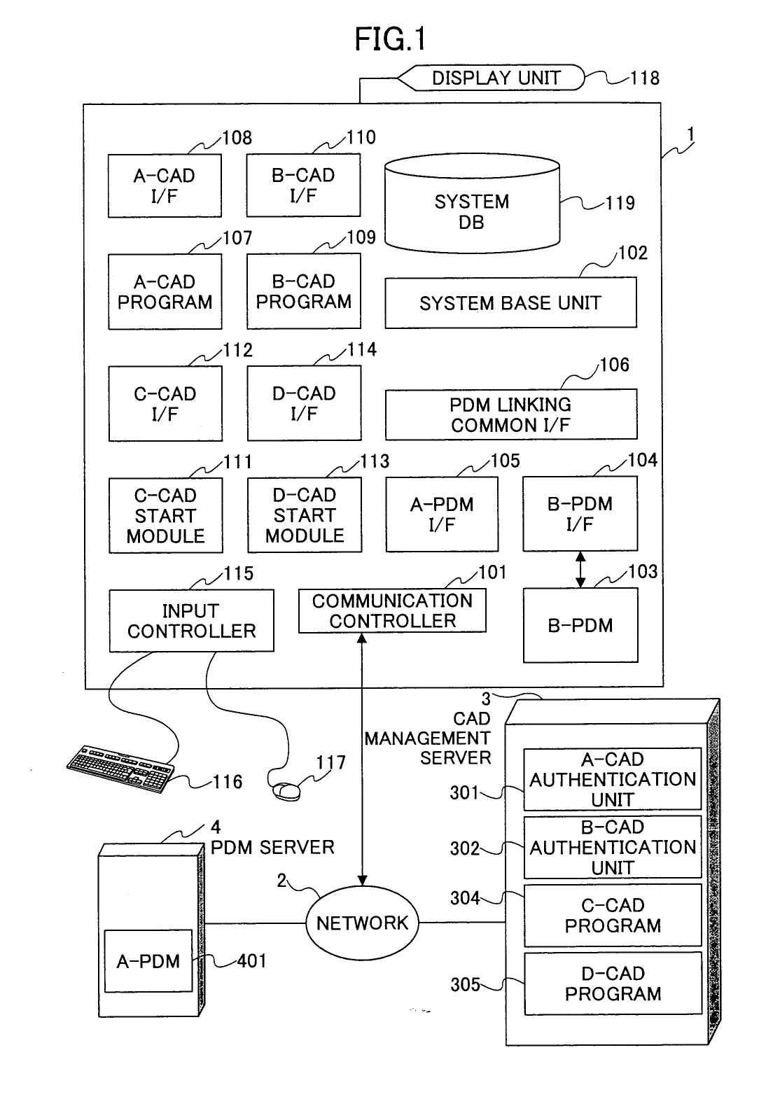

FIG. 1 is a diagram a showing a structure an embodiment of the CAD generation management system according to the present invention. This embodiment of the CAD generation management system employs an embodiment of the computer-readable storage medium according to the present invention. This embodiment of the computer-readable storage medium stores a computer program for causing a computer to function as the CAD generation management system.

A recording medium forming the computer-readable storage medium may be selected from any type of media capable of storing the computer program, such as magnetic recording media, optical recording media, magneto-optical recording media and semiconductor memory devices. In addition, the computer program may be prestored in the recording medium or, downloaded from another computer via one or more networks and stored in the recording medium.

The CAD generation management system shown in FIG. 1 is formed by a general purpose computer 1 having a processor such as a central processing unit (CPU) and a memory and/or storage. The memory and/or storage is used to store computer programs and modules to be executed by the processor, and to store various data to be used by the computer program, databases and intermediate data obtained by operations carried out during execution of the computer program.

The computer 1 is coupled to a CAD management server 3 and a PDM server 4 via one or a plurality of networks 2. The network may include a local area network (LAN) or the like. A keyboard 116, a mouse 117 and a display unit 118 are connected to the computer 1.

The computer 1 includes a communication controller 101, a system base unit 102, a CAD information database (B-PDM) 103, a B-PDM interface 104, an A-PDM interface 105, a PDM linking common interface 106, an A-CAD program 107, an A-CAD interface 108, a B-CAD program 109, a B-CAD interface 110, a C-CAD start module 111, a C-CAD interface 112, a D-CAD start module 113, a D-CAD interface 114, an input controller 115, and a system database (DB) 119.

The CAD management server 3 includes an A-CAD authentication unit 301, a B-CAD authentication unit 302, a C-CAD program 304, and a D-CAD program 305. The PDM server 4 includes a CAD information database (A-PDM) 401. For the sake of convenience, the CAD information database (PDM) of the PDM server 4 will be referred to as an A-PDM (401), and the CAD information database (PDM) of the computer 1 will be referred to as a B-PDM (103).

The computer 1 connects to the network 2 via the communication controller 101. The CAD management server 3 manages CAD programs which are used by the computer 1. In this embodiment, it is assumed for the sake of convenience that the computer 1 can use four kinds of CAD programs (A-CAD, B-CAD, C-CAD and D-CAD). It is also assumed for the sake of convenience that two CAD programs (A-CAD program 107 and B-CAD program 109) are preinstalled in the computer 1, and that the A-CAD authentication unit 301 and the B-CAD authentication unit 302 for authenticating the right to use the A-CAD and B-CAD programs 107 and 109, respectively, are preinstalled in the CAD management server 3.

In this embodiment, the remaining two CAD programs (C-CAD and D-CAD programs 304 and 305) are preinstalled in the CAD management server 3. When the computer 1 is to execute the C-CAD program 304 or the D-CAD program 305, the C-CAD program 304 or the D-CAD program 305 is acquired from the CAD management server 3 via the network 2 and starts the acquired CAD program 304 or 305 by the corresponding CAD start module 111 or 113.

The PDM server 4 includes the CAD information database (PDM), that is, the A-PDM 401. The CAD information includes information related to the CAD, such as screen information of the CAD. The PDM may also be provided in the computer 1, and in this embodiment, the B-PDM 103 is provided in the computer 1.

Next, a description will be given of the functions of the computer 1. The communication controller 101 controls the communication between the computer 1 and the network 2. The system base unit 102 carries out control related to the CAD. The B-PDM interface 104 converts the information from the B-PDM 103 into a format suited for use in the computer 1 or carries out a conversion complementary thereto. In general, the PDM is designed exclusively for each computer or server in most cases, and the data format used by the PDM is not the same among the PDMs. Hence, the A-PDM interface 105 and the B-PDM interface 104 are thus provided to absorb the differences in the data formats used by the different PDMs so as to enable the use of the PDMs in the computer 1, namely, the A-PDM 401 and the B-PDM 103 in this particular case.

The PDM linking common interface 106 is provided to enable the system base unit 102 to make a reference to (that is, read) and write the data of the A-PDM 401 and the B-PDM 103 at the same level.

The A-CAD interface 108 manages data such as meta data and bulk data which are temporarily generated during execution of the A-CAD program 107. The B-CAD interface 110 manages data such as meta data and bulk data which are temporarily generated during execution of the B-CAD program 109.

The C-CAD start module 111 is used to acquire the C-CAD program 304 from the CAD management server 3 and to start the C-CAD program 304 in the computer 1. The C-CAD interface 112 manages data such as meta data and bulk data which are temporarily generated during execution of the C-CAD program 304. The D-CAD start module 113 is used to acquire the D-CAD program 305 from the CAD management server 3 and to start the D-CAD program 305 in the computer 1. The D-CAD interface 114 manages data such as meta data and bulk data which are temporarily generated during execution of the D-CAD program 305.

A CAD interface is provided with respect to each CAD program. This is because, in general, the method of holding and the method of treating (processing) the meta data and the bulk data differ depending on the kind of CAD program.

The input controller 115 acquires input information from the keyboard 116 and the mouse 117. On the other hand, the display unit 118 displays various output information including messages.

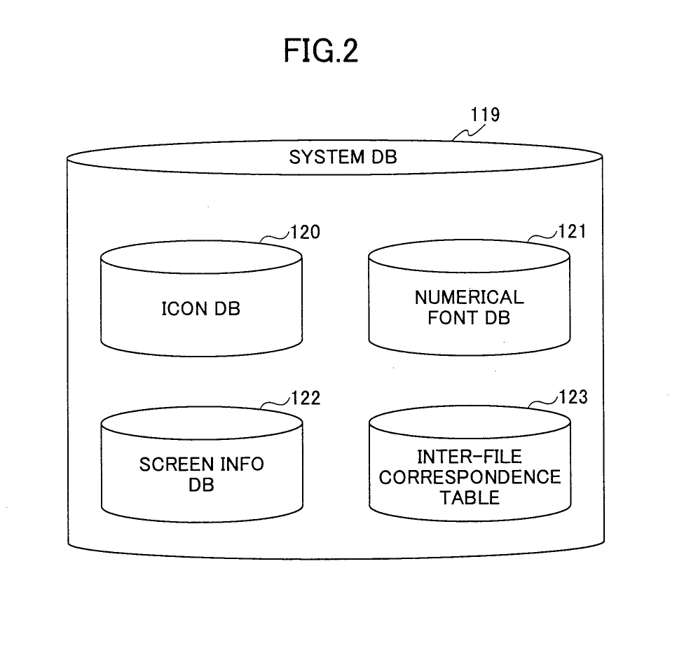

The system database 119 stores data which are used when carrying out a process related to the CAD (that is, a CAD-related process). FIG. 2 is a diagram showing a structure of the system database 119. The system database 119 includes an icon database (DB) 120, a numeric font database (DB) 121, a screen information database (DB) 122, and an inter-file correspondence table 123. The icon database 120 stores icon information, and the numeric font database 121 stores numeric font information. The screen information database 122 stores various screen information, and the inter-file correspondence table 123 stores relationship information of file information (CAD file information) stored in each PDM.

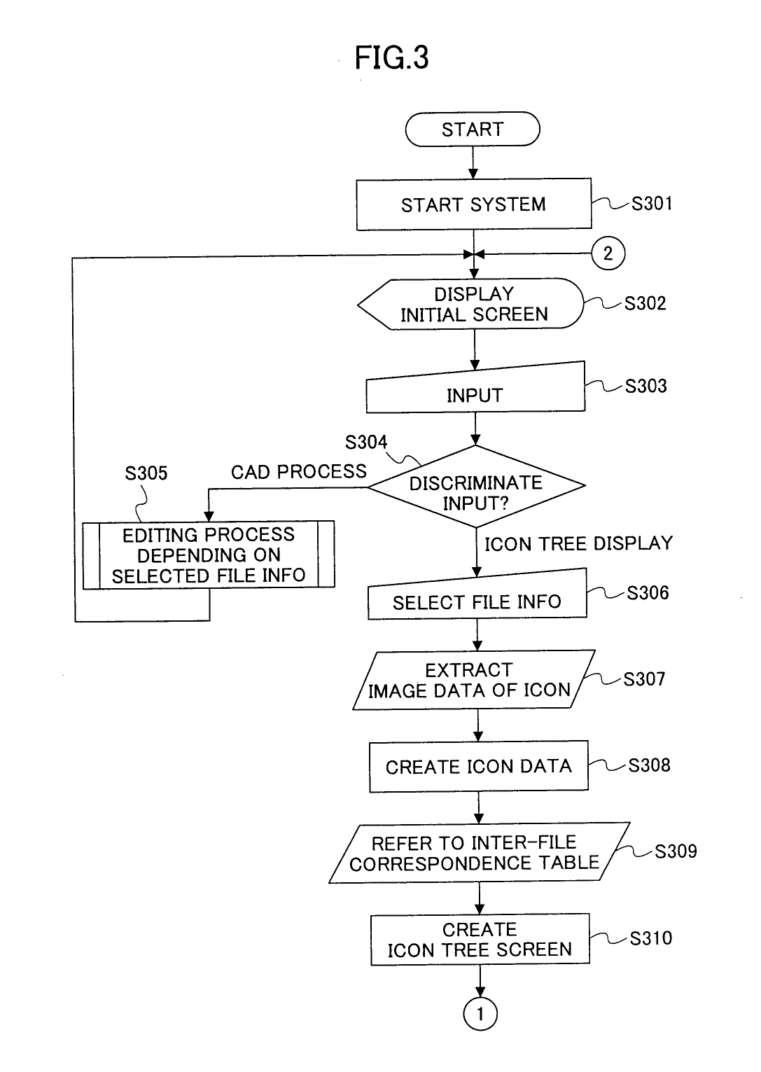

Next, a description will be given of an operation of the CAD generation management system shown in FIG. 1, by referring to FIG. 3. FIG. 3 is a flow chart for explaining the operation of the CAD generation management system.

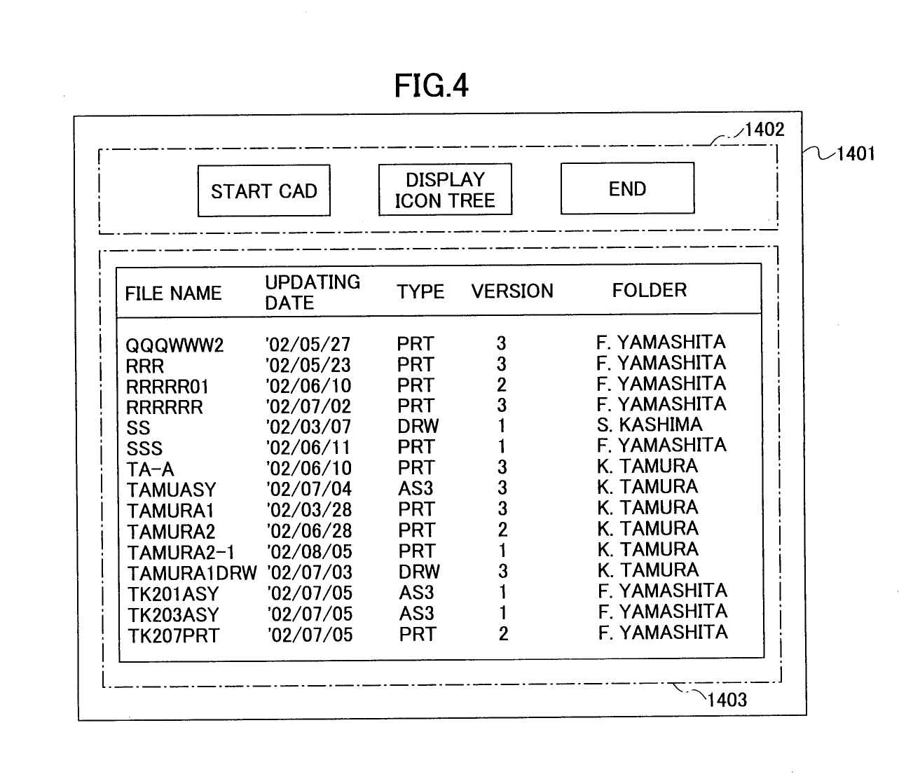

First, when the CAD generation management system is started in a step S301, the system base unit 102 acquires an initial screen 1401 shown in FIG. 4 from the screen information database 122 within the linking system database 119 and displays an icon group 1402 and CAD-related file information 1403 in a step S302. FIG. 4 is a diagram showing the initial screen 1401 displayed on the CAD generation management system.

The following display procedure is employed in this embodiment.

First, the system base unit 102 acquires each icon of the icon group 1402 from the screen information database 122 within the linking system database 119.

Then, the system base unit 102 acquires file information of the CAD-related file information 1403 by the following procedure. That is, the system base unit 102 inputs an instruction to acquire the file information to the PDM linking common interface 106, and in response to this instruction, a file information acquiring instruction is input to the A-PDM interface 105 and the B-PDM interface 104. Hence, the A-PDM interface 105 controls the communication controller 101 to connect to the PDM server 4 via the network 2, and acquires the file information from the A-PDM 401 within the PDM server 4. In addition, the B-PDM interface 104 acquires the file information from the B-PDM 103. The file information acquired from the A-PDM 401 or the B-PDM 103 is sent to the system base unit 102 via the PDM linking common interface 106. The CAD-related file information is acquired by the series of processes of this procedure.

The system base unit 102 creates the initial screen 1401 based on the icon information and the file information which are obtained in the above described manner, and displays the initial screen 1401 on the display unit 118.

After the display of the initial screen 1401 is completed, the user operates the keyboard 116 and/or the mouse 117 to select an icon or a file. When the input controller 115 detects the selection made by the user input in a step S303, the system base unit 102 discriminates the selected content in a step S304. In other words, the system base unit 102 decides whether the file information or the icon information is selected. The process advances to a step S305 if the file information is selected, and the process advances to a step S306 if the icon information is selected.

If one of the file information is selected, the CAD program corresponding to the selected file information carries out an editing process in a step S305. The process returns to the step S302 after the editing process of the step S305 is completed.

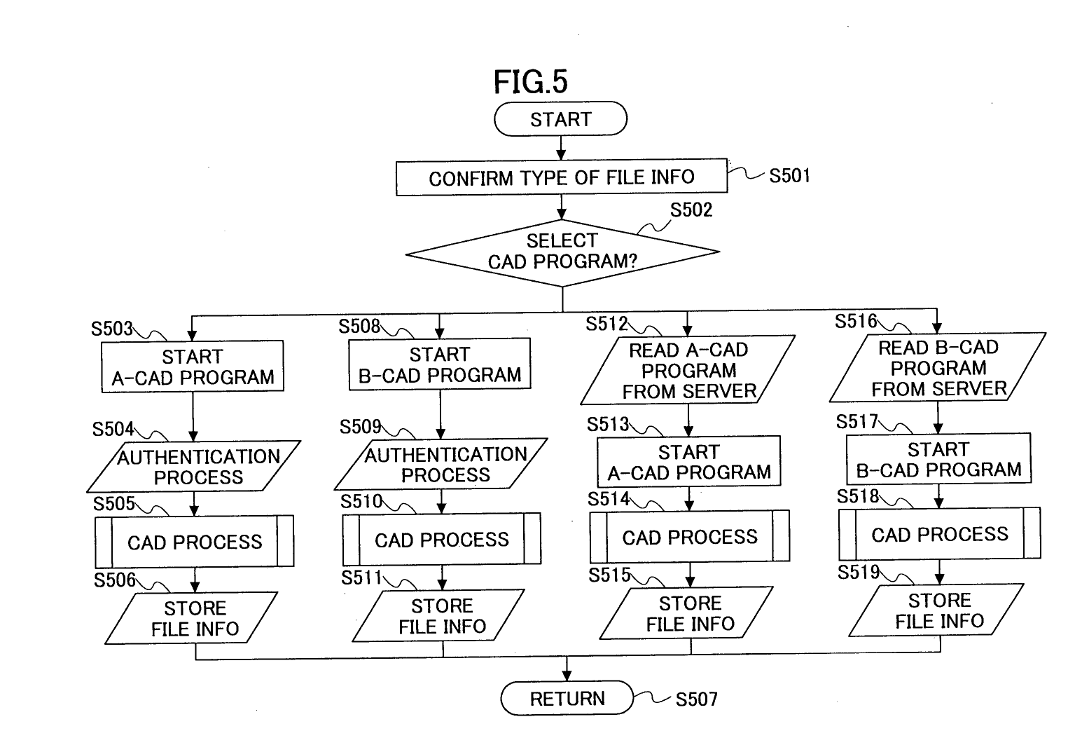

A description will be given of the editing process of the CAD program, by referring to FIG. 5. FIG. 5 is a flow chart for explaining the editing process of the CAD program.

In FIG. 5, the system base unit 102 confirms the type of file information in a step S501, based on type information added to the file information, file type information such as an extender included within a file name, and the like. In this embodiment, the type information can also be confirmed in relation to the file name of the file information as in the case of the initial screen 1401 shown in FIG. 4. Next, the system base unit 102 selects a CAD program to be used depending on the type information, in a step S502. The CAD program may be selected by storing a table of corresponding relationships of the CAD programs and the types of file information within the system database 119 by the system base unit 102, and referring to this table so as to select the CAD program from the type of file information (type information).

If the A-CAD program 107 is selected in the step S502, the system base unit 102 starts the A-CAD program 107 in a step S503. In this case, the started A-CAD program 107 carries out an authentication process in a step S504. This authentication process is carried out as follows.

That is, the A-CAD program 107 controls the communication controller 101 to connect to the CAD management server 3, and sends an authentication request to the CAD management server 3. Responsive to the authentication request, the A-CAD authentication unit 301 of the CAD management server 3 sends an authentication enable to the computer 1. The authentication process is carried out when the A-CAD program 107 receives the authentication enable via the communication controller 101.

The A-CAD program 107 assumes an editable state when the authentication process is completed.

Thereafter, the A-CAD program 107 reads the corresponding file information into the A-CAD program 107, so that the editing of the corresponding file in formation by the A-CAD program 107 is possible, in a step S505. Hence, the user can carry out an editing operation (or CAD process) by the A-CAD program 107 which is executed in the computer 1, in the step S505.

After the user carries out the CAD process and the CAD process is completed by carrying out an end operation or the like, the system base unit 102 carries out a file store process in a step S506 to store the file information which is edited. More particularly, the system base unit 102 inputs to the PDM linking common interface 106 a store instruction to store the corresponding file information, and depending on this store instruction, a file information store instruction and the corresponding file information is sent to the A-PDM interface 105 or the B-PDM interface 104 which stores the file information. If the file information store instruction is sent to the A-PDM interface 105, the communication controller 101 is controlled to connect the computer 1 to the PDM server 4 via the network 2, and the storage of the corresponding file information is requested to the A-PDM 401 of the PDM server 4. Hence, the PDM server 4 stores the corresponding file information in the A-PDM 401. On the other hand, if the file information store instruction is sent to the B-PDM interface 104, the corresponding file is stored in the B-PDM 103. When the storage of the file information in the A-PDM 401 or the B-PDM 103 is completed, this completion is notified to the system base unit 102 via the PDM linking common interface 106, and the file store process is completed. As a result, the CAD process is completed in a step S507.

If the B-CAD program 109 is selected in the step S502, the system base unit 102 starts the B-CAD program 109 in a step S508. In this case, the started B-CAD program 109 carries out an authentication process in a step S509. Thereafter, the B-CAD program 109 reads the corresponding file information into the B-CAD program 109, so that the editing of the corresponding file in formation by the B-CAD program 109 is possible, in a step S510. Hence, the user can carry out an editing operation (or CAD process) by the B-CAD program 109 which is executed in the computer 1, in the step S510. After the user carries out the CAD process and the CAD process is completed by carrying out an end operation or the like, the system base unit 102 carries out a file store process in a step S511 to store the file information which is edited, and the file store process is completed in the step S507. Therefore, the steps S508 through S511 are carried out similarly to the steps S503 through S506.

If the C-CAD program 304 is selected in the step S502, the system base unit 102 starts the C-CAD start module 111 in a step S512. In addition, the started C-CAD start module 111 carries out a read process to read the C-CAD program 304 from the CAD management server 3, in the step S512. Further, the C-CAD start module 111 starts the read C-CAD program 304 in a step S513.

The C-CAD program 304 reads the corresponding file information into the C-CAD program 304, so that the editing of the corresponding file in formation by the C-CAD program 304 is possible, in a step S514. Hence, the user can carry out an editing operation (or CAD process) by the C-CAD program 304 which is executed in the computer 1, in the step S514.

After the user carries out the CAD process and the CAD process is completed by carrying out an end operation or the like, the system base unit 102 carries out a file store process in a step S515 to store the file information which is edited. More particularly, the system base unit 102 inputs to the PDM linking common interface 106 a store instruction to store the corresponding file information, and depending on this store instruction, a file information store instruction and the corresponding file information is sent to the A-PDM interface 105 or the B-PDM interface 104 which stores the file information. If the file information store instruction is sent to the A-PDM interface 105, the communication controller 101 is controlled to connect the computer 1 to the PDM server 4 via the network 2, and the storage of the corresponding file information is requested to the A-PDM 401 of the PDM server 4. Hence, the PDM server 4 stores the corresponding file information in the A-PDM 401. On the other hand, if the file information store instruction is sent to the B-PDM interface 104, the corresponding file is stored in the B-PDM 103. When the storage of the file information in the A-PDM 401 or the B-PDM 103 is completed, this completion is notified to the system base unit 102 via the PDM linking common interface 106, and the file store process is completed. As a result, the CAD process is completed in the step S507.

If the D-CAD program 305 is selected in the step S502, the system base unit 102 starts the D-CAD start module 113 in a step S516. In addition, the started D-CAD start module 113 carries out a read process to read the D-CAD program 305 from the CAD management server 3, in the step S516. Further, the D-CAD start module 113 starts the read D-CAD program 305 in a step S517. The D-CAD program 305 reads the corresponding file information into the D-CAD program 305, so that the editing of the corresponding file in formation by the D-CAD program 305 is possible, in a step S518. Hence, the user can carry out an editing operation (or CAD process) by the D-CAD program 305 which is executed in the computer 1, in the step S518. After the user carries out the CAD process and the CAD process is completed by carrying out an end operation or the like, the system base unit 102 carries out a file store process in a step S519 to store the file information which is edited, and the file store process is completed in the step S507. Therefore, the steps S516 through S519 are carried out similarly to the steps S512 through S515.

In FIG. 5, the file information is stored after the CAD process is completed. However, it is of course possible to store the file information during the CAD process by the CAD program in response to an operation made by the user.

In a case where a plurality of users jointly carry out the CAD process using the CAD program, if one user modifies the contents of certain file information, this modification affects file information of other users. Hence, the CAD generation management system manages generations of the file information. More particularly, both the file information prior to the modification and the file information after the modification are stored, and the two file information are distinguished from each other by adding generation information (version information) indicating the generation (version) of each file information. The version information is updated every time the file information is updated, and the version information is stored in the PDM together with the file information. In the initial screen 1401 shown in FIG. 4, the CAD-related file information 1403, which is a list of file information, includes a version number indicating the last (most recently updated) version information of the file information. As shown in FIG. 4, the CAD-related file information 1403 includes the file name, an updated date, the type, the version and a folder (folder name) of the file information.

Next, a description will be given of a case where one of the icon information is selected in the step S304 shown in FIG. 3. More particularly, a description will be given of the case where an icon of “icon tree display” for inspecting the corresponding relationships of the files as the icon information is selected.

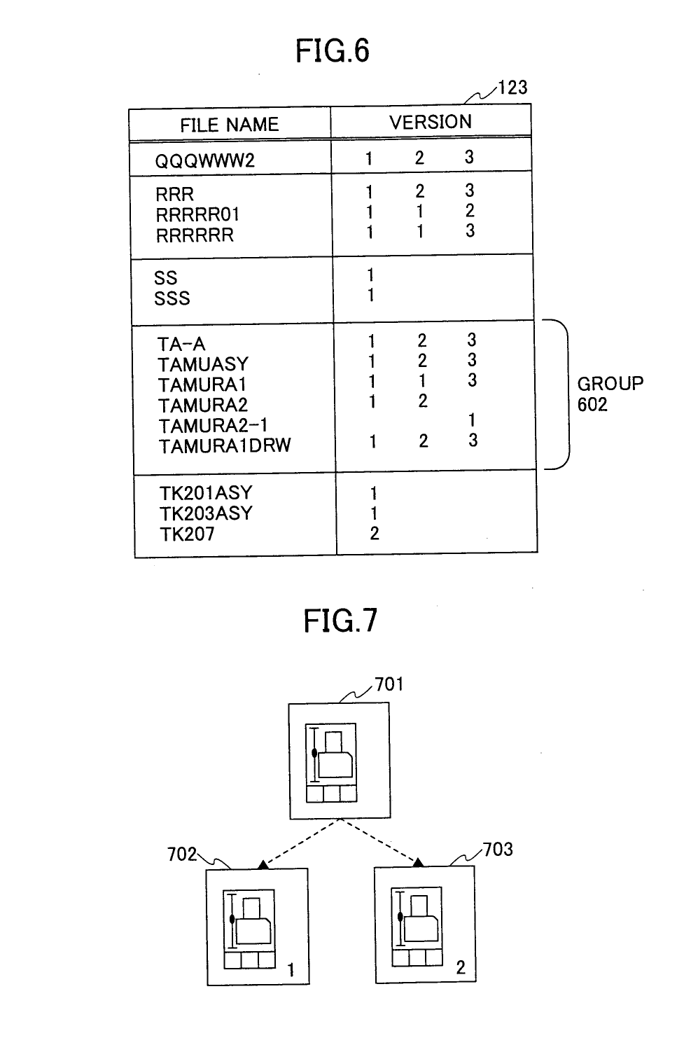

In this case, after the “icon tree display” is selected, when the input controller 101 detects in a step S306 shown in FIG. 3 that the user has selected the file information by use of the keyboard 116 or the mouse 117, the system base unit 102 refers to the inter-file correspondence table 123 within the system database 119. FIG. 6 is a diagram showing a structure of the inter-file correspondence table 123. As shown in FIG. 6, the inter-file correspondence table 123 indicates the corresponding relationship between the file name and the version of each file information. For example, version “1” of file information TA-A shown in FIG. 6 is related to version “1” of related file information TAMUASY, TAMURA1, TAMURA2 and TAMURALDRW. In addition, version “2” of the file information TA-A is related to version “2” of the related file information TAMUASY, TAMURA2 and TAMURA1DRW and to the version “1” of the related file information TAMURA1.

For the sake of convenience, it is assumed that the file information TA-A is selected in the step S306. Hence, the system base unit 102 refers to the inter-file correspondence table 123, and extracts image data of the icons related to the file information TA-A and the file information TAMUASY, TAMURA1, TAMURA2 and TAMURALDRW which belong to the same group 602 as the file information TA-A, from the icon database 120, in a step S307.

Next, the system base unit 102 confirms the version information of the file information TA-A and the file information TAMUASY, TAMURA1, TAMURA2 and TAMURALDRW which belong to the same group 602 as the file information TA-A, and creates icon data added with numerical information for each version information, in a step S308. More particularly, in an icon data creating process of the step S308, the numerical information indicating the version information is assembled into the icon information which is read in advance.

For example, the icon data for the file information TAMURA1DRW is an icon data 701 shown in FIG. 7. FIG. 7 is a diagram for explaining the icon data creating process. In this case, when a reference is made to the inter-file correspondence table 123, it is found that the versions “1” and “2” exist for the file information. Hence, numeric values “1” and “2” indicating the versions are extracted from the numeric font database 121 within the system database 119 and assembled into the icon data 701, so as to create icon data 702 and 703 shown in FIG. 7 which are added with the version information. The other icon data are created similarly for each version information.

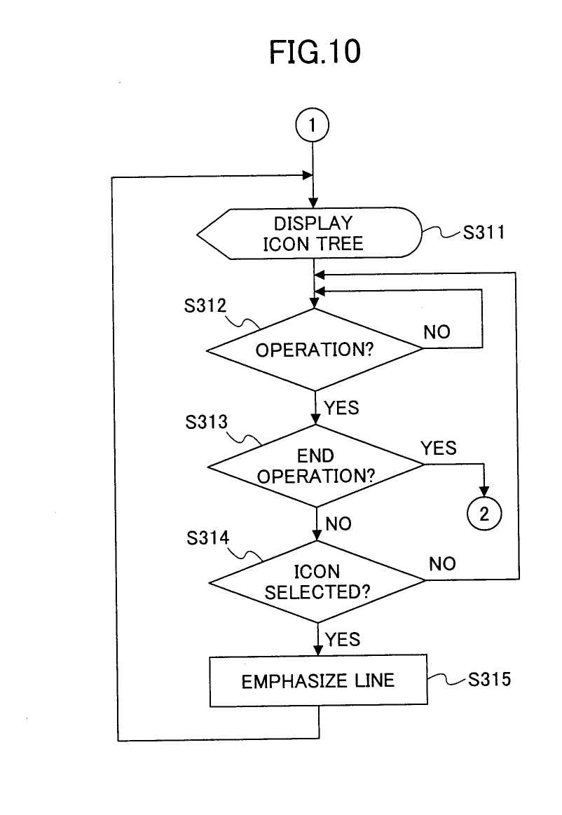

Thereafter, the system base unit 102 refers to the inter-file correspondence table 123 in a step S309, and creates an icon tree screen in a step S310. After the step S310, the process advances to a step S311 shown in FIG. 10 which carries out an icon data (icon tree) display process.

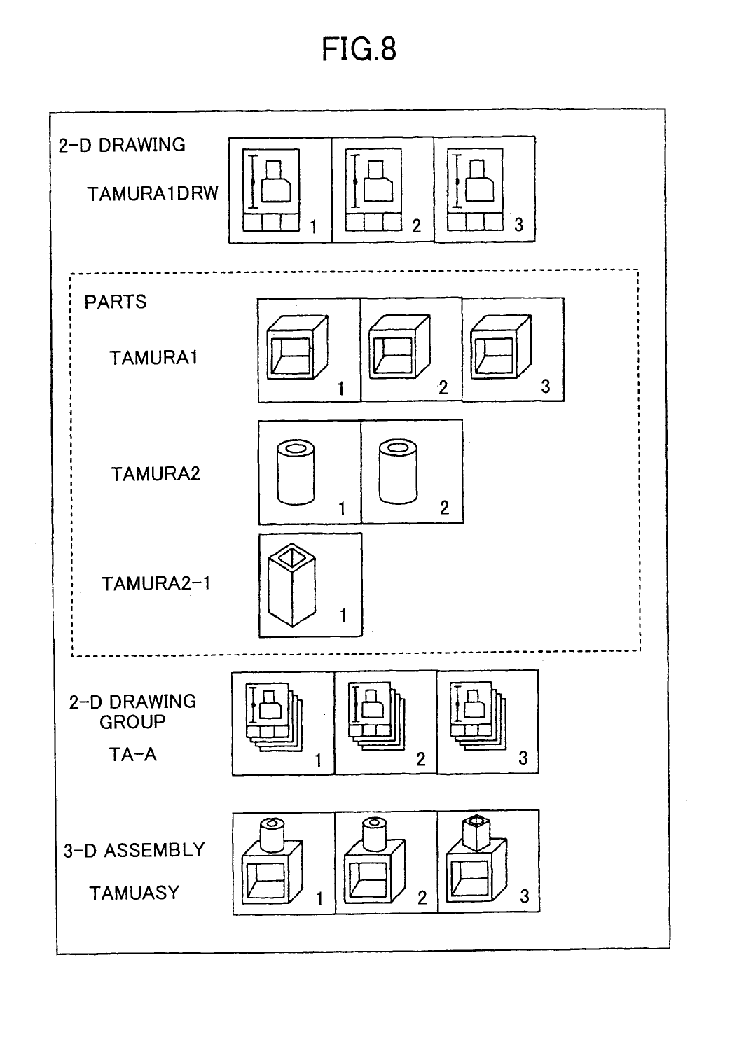

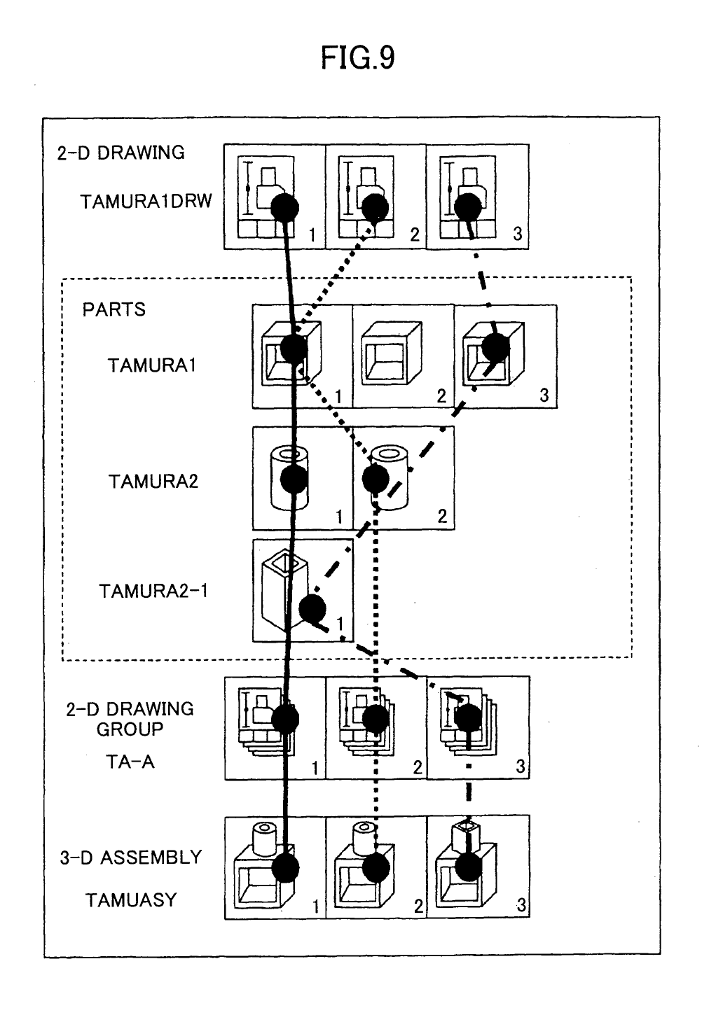

FIGS. 8 and 9 are diagrams for explaining the icon data display process. FIG. 10 is a flow chart for explaining the operation of the CAD generation management system. The icon data display process is carried out in the following manner.

First, the system base unit 102 arranges the icon data of each of the file information for each version information, as shown in FIG. 8. In FIG. 8, the file information includes a two-dimensional drawing TAMURA1DRW, parts TAMURA1, TAMURA2 and TAMURA2-1, a two-dimensional drawing group TA-A, and a three-dimensional assembly TAMUASY.

Next, the system base unit 102 refers to the inter-file correspondence table 123, and connects the related icons depending on the relationships of the version information, as shown in FIG. 9. The icon data (icon tree) display is easier to understand if the kind, width and color of the lines connecting the icons are set differently for each version information. FIG. 9 shows a case where the kind of line includes a solid line, a dotted line and a one-dot chain line.

The system base unit 102 displays the icon data (icon tree) which is created as described above on the display unit 118 in the step S311 shown in FIG. 10. In this embodiment, the icon data is created first and then displayed, but it is of course possible to display the icon data while being created.

By arranging and displaying each file information for each version information and indicating the relationships of the file information by the lines which connect the file information, it becomes possible for the user to visually and easily understand the relationships of the file information. In this embodiment, there are only six related file information, but in actual practice, the number of related file information in the CAD generation management system may be on the order of several hundred or more. When the number of related file information is large, it requires a difficult and time-consuming operation to confirm the relationship of a target file information to the other file information and the versions of the other file information if the conventional method is employed, because the conventional method only relies on the file name and the related information. But according to this embodiment, it is possible to visually and easily confirm the relationship of the target file information to the other file information and the versions of the other file information.

After the step S311, the system base unit 102 confirms whether or not an operation is made by the user in a step S312, by detecting via the input controller 115 whether or not an input is made from the keyboard 116 or the mouse 117. The operation is waited in the step S312, and the process advances to a step S313 if the decision result in the step S312 becomes YES.

When the operation is detected by the input controller 115 and the decision result in the step S312 is YES, the system base unit 102 confirms whether or not an end operation is carried out in a step S313. If the decision result in the step S313 is YES, the process returns to the step S302 shown in FIG. 3, so as to return to the display of the initial screen 1401.

On the other hand, if the decision result in the step S313 is NO, the system base unit 102 confirms whether or not an icon (icon information) is selected in a step S314. If the decision result in the step S314 is NO, it is regarded that an input is invalid, and the process returns to the step S312.

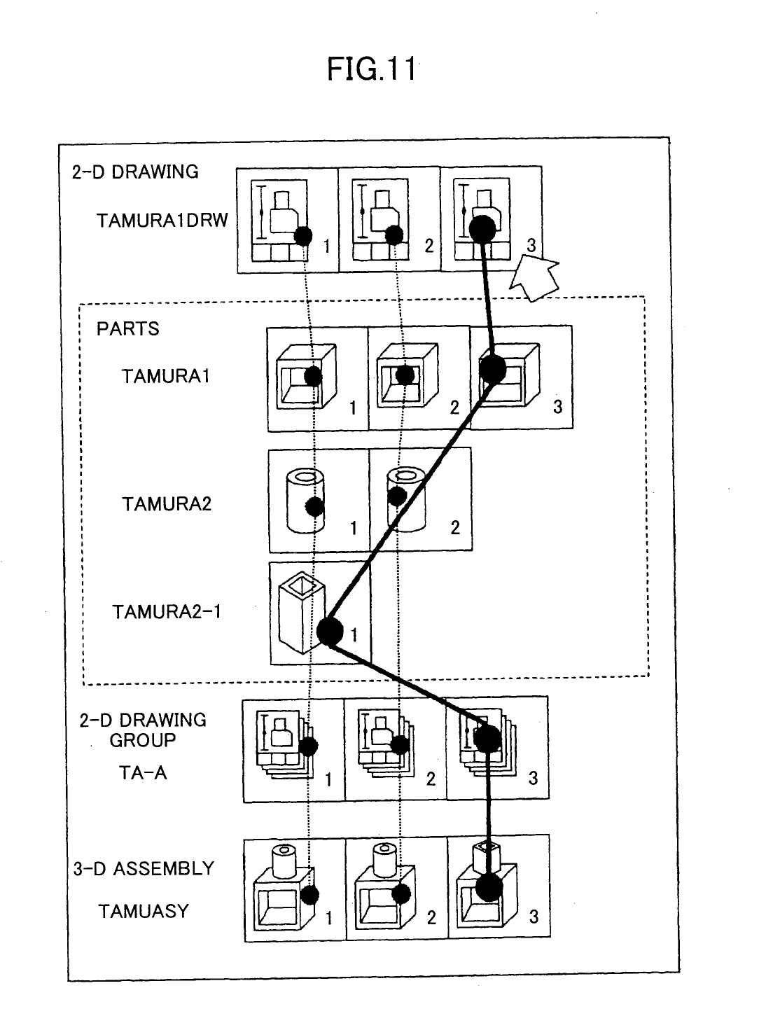

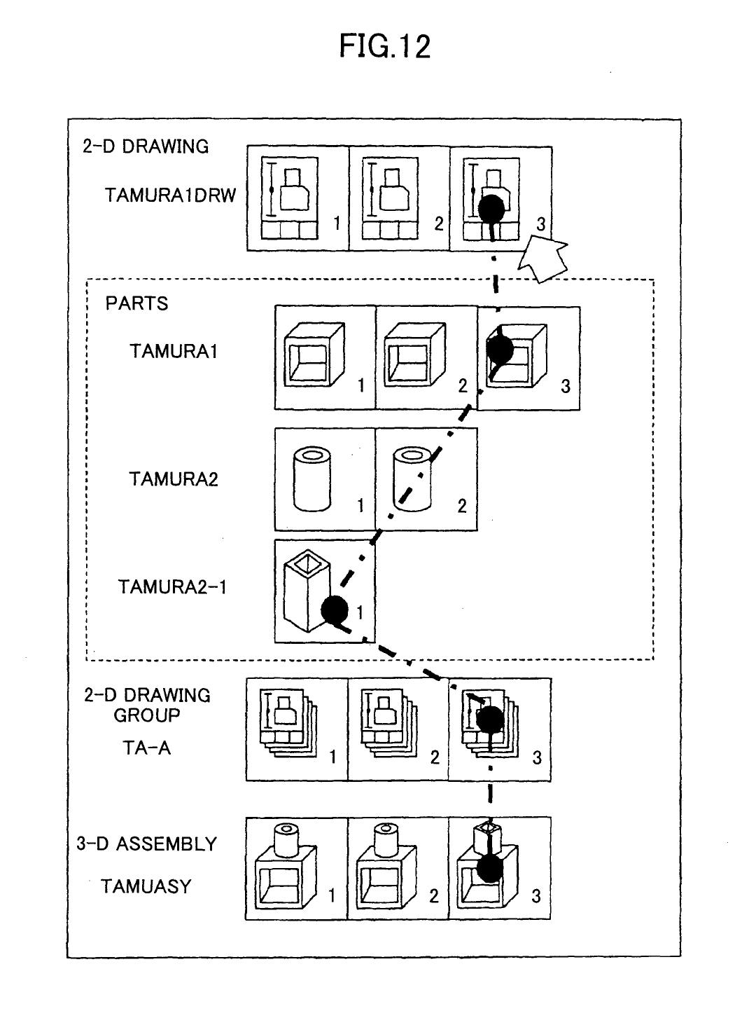

On the other hand, if the decision result in the step S314 is YES, the system base unit 102 carries out a line emphasis process to emphasize the lines related to the selected icon (icon information). For example, if the icon of the version “3” of the file information TAMURALDRW is selected, the width of the lines which are unrelated to the selected icon may be reduced or, the kind of the lines which are unrelated to the selected icon may be changed, with respect to the lines which are related to the selected icon, as shown in FIG. 11. In addition, if the icon of the version “3” of the file information TAMURALDRW is selected, the lines which are unrelated to the selected icon may be erased as shown in FIG. 12. FIGS. 11 and 12 are diagrams for explaining the icon data display process. In FIGS. 11 and 12, those parts which are the same as those corresponding parts in FIGS. 8 and 9 are designated by the same reference numerals, and a description thereof will be omitted.

In this embodiment, a new icon is created for each version information by combining the image data of the icon and the numerical font information. Normally, the version information is merely displayed as text information below the icon, for example, and the icon does not occupy a region greater than or equal to the image. In addition, since the icon data with the added version information is created by combining the numerical font information and the icon data, it is possible to display the icon data of all of the versions even if not all of the icon data for each version is held with respect to all of the file information.

Further, the present invention is not limited to these embodiments, but various variations and modifications may be made without departing from the scope of the present invention.

What is claimed is:

1. A CAD generation management system comprising:
a storage section to store file information in units of generations;
an inter-file correspondence table to store corresponding relationships of the file information stored in the storage, including generation information;
an icon storage to store icon data corresponding to the file information; and
a unit to refer to the inter-file correspondence table and the icon storage and to display icon data of the file information stored in the storage section in units of generations, and to display relationships of the file information corresponding to the icon data.

2. The CAD generation management system as claimed in claim 1, further comprising:
an input controller to detect an input to the CAD generation management system, said unit displaying the relationships of selected icon data with emphasis when the input controller detects an input selecting the selected icon data from the displayed icon data.

3. The CAD generation management system as claimed in claim 1, wherein the unit displays the relationships of the file information corresponding to the icon data by lines connecting related icon data.

4. The CAD generation management system as claimed in claim 3, wherein a kind, width and color of the lines connecting the icon data are set differently for each generation.

5. The CAD generation management system as claimed in claim 1, further comprising:
means for acquiring a CAD program and/or the file information via one or more networks.

6. A CAD generation management system comprising:
a first storage to store font information indicating generation information;
a second storage to store icon data indicating file information;
a third storage to store the generation information of the file information; and
a unit to refer to the generation information stored in the third storage in response to an instruction to display generation information of target file information, and to create and display the icon data related to the generation information to be displayed by combining the font information stored in the first storage and the icon data stored in the second storage.

7. The CAD generation management system as claimed in claim 6, further comprising:
an input controller to detect an input to the CAD generation management system, including the instruction,
said unit displaying the relationships of selected icon data with emphasis when the input controller detects an input selecting the selected icon data from the displayed icon data.

8. The CAD generation management system as claimed in claim 6, wherein the unit displays the relationships of the file information corresponding to the icon data by lines connecting related icon data.

9. The CAD generation management system as claimed in claim 8, wherein a kind, width and color of the lines connecting the icon data are set differently for each generation.

10. The CAD generation management system as claimed in claim 6, further comprising:
means for acquiring a CAD program and/or the file information via one or more networks.

11. A computer-readable storage medium which stores a computer program for causing a computer to manage generation information of file information, said computer program comprising:
a procedure to cause the computer to store file information in a storage in units of generations;
a procedure to cause the computer to store corresponding relationships of the file information stored in the storage, including generation information, in an inter-file correspondence table;
a procedure to cause the computer to store icon data corresponding to the file information in an icon storage; and
a control procedure to cause the computer to refer to the inter-file correspondence table and the icon storage and to display icon data of the file information stored in the storage section in units of generations, and to display relationships of the file information corresponding to the icon data.

12. The computer-readable storage medium as claimed in claim 11, wherein said computer program further comprises:
an input procedure to cause the computer to detect an input to the computer,
said control procedure causing the computer to display the relationships of selected icon data with emphasis when the input controller detects an input selecting the selected icon data from the displayed icon data.

13. The computer-readable storage medium as claimed in claim 11, wherein the control procedure causes the computer to display the relationships of the file information corresponding to the icon data by lines connecting related icon data.

14. The computer-readable storage medium as claimed in claim 13, wherein a kind, width and color of the lines connecting the icon data are set differently for each generation.

15. The computer-readable storage medium as claimed in claim 11, wherein said computer program further comprises:
a procedure to cause the computer to acquire a CAD program and/or the file information via one or more networks.

16. A computer-readable storage medium which stores a computer program for causing a computer to manage generation information of file information, said computer program comprising:
a procedure to cause the computer to store font information indicating generation information in a first storage;
a procedure to cause the computer to store icon data indicating file information in a second storage;
a procedure to cause the computer to store the generation information of the file information in a third storage; and
a control procedure to cause the computer to refer to the generation information stored in the third storage in response to an instruction to display generation information of target file information, and to create and display the icon data related to the generation information to be displayed by combining the font information stored in the first storage and the icon data stored in the second storage.

17. The computer-readable storage medium as claimed in claim 16, wherein said computer program further comprises:
an input procedure to cause the computer to detect an input to the computer, including the instruction,
said control procedure causing the computer to display the relationships of selected icon data with emphasis when the input controller detects an input selecting the selected icon data from the displayed icon data.

18. The computer-readable storage medium as claimed in claim 16, wherein the control procedure causes the computer to display the relationships of the file information corresponding to the icon data by lines connecting related icon data.

19. The computer-readable storage medium as claimed in claim 18, wherein a kind, width and color of the lines connecting the icon data are set differently for each generation.

20. The computer-readable storage medium as claimed in claim 16, wherein said computer program further comprises:
a procedure to cause the computer to acquire a CAD program and/or the file information via one or more networks.
